(19) United States
(12) Patent Application Publication
(10) Pub. No.: US 2001/0008415 A1
(43) Pub. Date: Jul. 19, 2001

(54) Wireless video monitoring system utilizing a wireless portable telephone

(75) Inventor: Chun-Ho Park, Seoul (KR)

Correspondence Address: Paul J. Farrell, Esq., DILWORTH & BARRESE, 333 Earle Ovington Boulevard, Uniondale, NY, 11553, US

(73) Assignee: Samsung Electronics Co., Ltd.

(21) Appl. No.: 09/761,037

(22) Filed: Jan. 16, 2001

(30) Foreign Application Priority Data
Jan. 15, 2000 (KR) 2000-1873

(51) Int. Cl. H04N 7/18

(52) U.S. Cl. 348/143

(57) ABSTRACT

There is provided a wireless video monitoring system which includes a wireless camera which transmits video data of a monitored object in the form of an RF signal. A wireless telephone receives the RF signal from the wireless camera via a base station, and demodulates the RF signal and displays the monitored object on a display through a portable terminal.

### BACKGROUND OF THE INVENTION

1. Field of the Invention

The present invention relates generally to a video monitoring system, and in particular, to a wireless video monitoring system.

2. Description of the Related Art

A CC TV (Closed Circuit TeleVision) installed to monitor a specific object, usually is done so at a high cost. For example, apartment buildings may now be provided with CC TVs for monitoring children in a playground or indoor/outdoor situations, and may also be used to monitor activities in specific rooms or common areas.

Monitoring activities with a CC TV camera is confined to the place where it is installed. For example, if a CC TV is installed in a living room, a user can be monitored as long as he remains in a particular place, say, before the CC TV. In other words, if the user moves to another place, monitoring is interrupted.

Besides, since a CC TV camera is installed in a fixed position, it can only photograph an object at a predetermined angle from the position it is placed without being able to freely move to monitor other objects or places.

### SUMMARY OF THE INVENTION

It is, therefore, an object of the present invention to provide a wireless video monitoring system which facilitates unrestricted monitoring of objects or places through the provision of a portable wireless CCTV camera system and allows a user to move from place to place during monitoring via a wireless terminal.

To achieve the above objects, there is provided a wireless video monitoring system. In the wireless video monitoring system, a wireless camera transmits video data of a monitored object in the form of an RF signal. A wireless receiver, such as a wireless telephone, receives the RF signal from the wireless camera via a fixture, and demodulates the RF signal and displays the monitored object on a display through a portable terminal.

### BRIEF DESCRIPTION OF THE DRAWINGS

The above and other objects, features and advantages of the present invention will become more apparent from the following detailed description when taken in conjunction with the accompanying drawing, wherein:

FIG. 1 illustrates a wireless video monitoring system according to an embodiment of the present invention; and

FIG. 2 illustrates a block diagram of the wireless camera and the wireless terminal according to an embodiment of the present invention.

### DETAILED DESCRIPTION OF THE PREFERRED EMBODIMENT

A preferred embodiment of the present invention will be described hereinbelow with reference to the accompanying drawings. In the following description, well-known functions or constructions are not described in detail since they would obscure the invention in unnecessary detail.

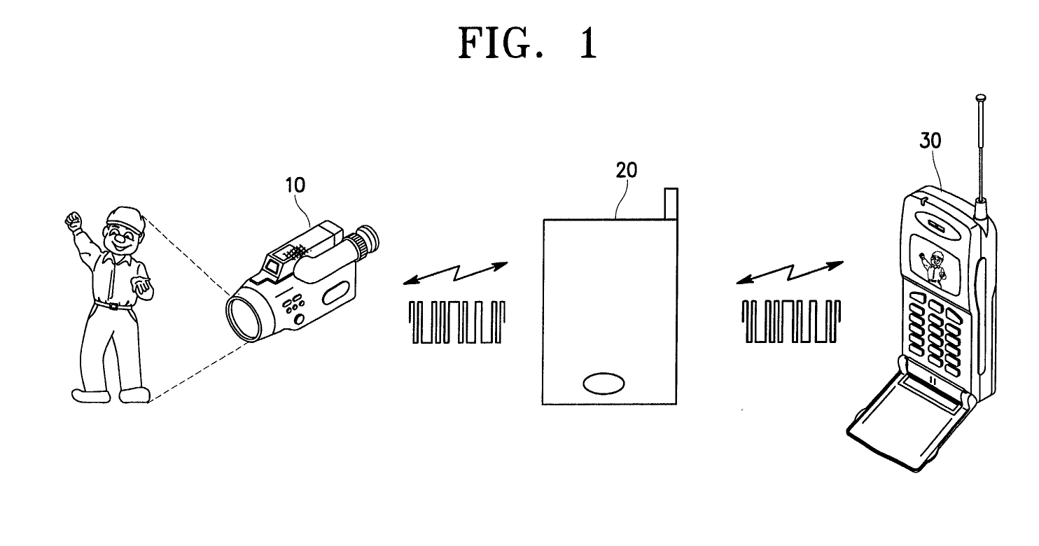

Referring to FIG. 1, a wireless camera 10 transmits video data of a monitored object in the form of an RF (Radio Frequency) signal. A fixture 20, such as a base station, of a wireless telephone system receives the RF signal from the wireless camera 10 and a portable wireless terminal 30 of the wireless telephone system demodulates the RF signal received from the base station 20 and displays the monitored object on a display of portable wireless terminal 30.

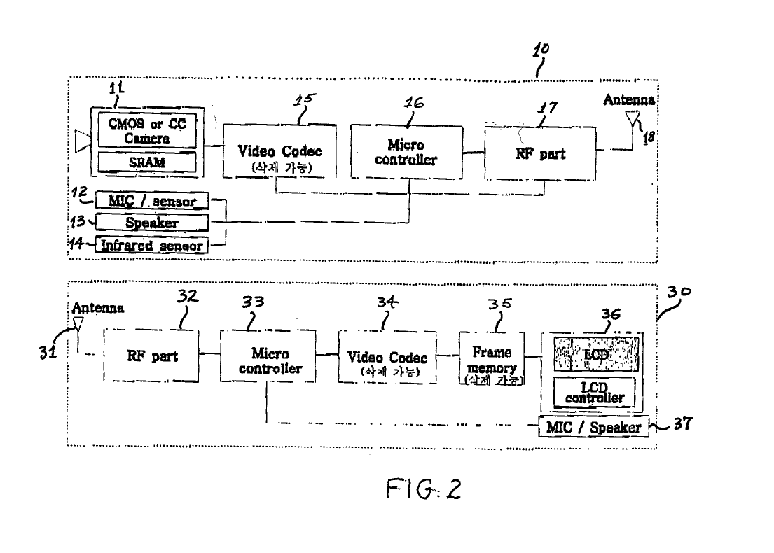

Referring to FIG. 2, there is shown a block diagram of the wireless camera 10 and the wireless terminal 30. Wireless camera 10 includes a CMOS or CC camera 11, a microphone 12 and speaker 13, and an infrared sensor 14, for recording video images of the object or person to be monitored. The picture images are sent to video codec 15, while sound picked up by the microphone 12, and movement sensed by sensor 16 are monitored under the control of microcontroller 16. The output of codec 15 and microcontroller 16 are sent to RF part 17, for modulation and transmission through antenna 18.

Signals sent by antenna 18 of wireless camera 10 are received by wireless terminal 30 through antenna 31. The received signals are demodulated by RF part 32 and sent to microcontroller 33. Video codec 34 then receives the signal and sends the video image to frame memory 35, for output and display on an LCD display of the portable wireless terminal 30. Sound is reproduced through speaker 37.

The wireless camera 10 optimizes the monitored video data in accordance with the LCD resolution of wireless terminal 30 so that it may be displayed on the display of the portable terminal 30. The display may be preferably an LCD (Liquid Crystal Display) panel. Alternatively, the wireless terminal 30 may optimize the video data in accordance with the resolution of wireless camera 30.

A cordless telephone such as the digital enhanced cordless telecommunications (DECT) telephone can be used as the wireless terminal 30. In other words, the RF signal is generated from the wireless camera 10, for example, in TDMA (Time Division Multiple Access), TDD (Time Division Duplex), a spread spectrum scheme, or an analog RF scheme. The frequency of the RF signal can range from 900-930 MHz, 1.88-1.94 GHz, or 2.4 GHz-2.5 GHz.

The wireless camera 10 is capable of continuously transmitting monitored video data in real time or as still images to the portable terminal 30 so that the portable terminal 30 can display the video data on the display at any time when the user wants. Alternatively, the wireless camera 10 may be activated in response to a driving command, such a noise or sound that is picked up by microphone 12 that exceeds a threshold level. Infrared sensor 14 may also be used to activate camera 10, by detecting some type of movement. Furthermore, wireless terminal 30 may include a keypad (not shown), connected to microcontroller 33, which includes a key or set of keys which activates camera 10 when pressed.

In accordance with the present invention as described above, children playing in a playground or other indoor/outdoor situations can be monitored through the display of a portable terminal in a wireless phone without installing a CC TV. Therefore, the cost of the CC TV is saved. Furthermore, the mobility of the portable terminal allows a user to move during monitoring and since the CC camera is wireless, the user can install the CC camera freely in an intended place.

While the invention has been shown and described with reference to a certain preferred embodiment thereof, it will be understood by those skilled in the art that various changes in form and detail may be made therein without departing from the spirit and scope of the invention as defined by the appended claims.

What is claimed is:

1. A wireless video monitoring system comprising:
a wireless camera for transmitting video data of a monitored object in the form of an RF signal; and
a wireless terminal for receiving the RF signal, demodulating the RF signal, and displaying the monitored object on a display.

2. The wireless video monitoring system of claim 1, wherein the wireless camera optimizes the video data in accordance with the resolution of the display of the wireless terminal to display the video data on the display.

3. The wireless video monitoring system of claim 1, wherein the wireless camera is activated upon receipt of a driving command.

4. The wireless video monitoring system of claim 1, wherein the wireless telephone is a digital enhanced cordless telecommunications (DECT) telephone.

5. The wireless video monitoring system of claim 3, wherein the driving command is generated at the wireless camera.

6. The wireless video monitoring system of claim 3, wherein the driving command is generated at the wireless terminal.

7. The wireless video monitoring system of claim 5, wherein the camera includes an infrared sensor to detect movement, said driving command being generated in response to a signal generated by said infrared sensor.

8. The wireless video monitoring system of claim 5, wherein the camera includes a microphone to detect sound, said driving command being generated in response to a signal generated by said microphone.

9. The wireless video monitoring system of claim 6, wherein the wireless terminal includes a keypad, said driving command being generated in response to a signal generated by pressing a key on said keypad.

10. A wireless video monitoring system comprising:
a wireless camera for transmitting video data as an RF signal; and
a wireless telephone for receiving the RF signal;
wherein the wireless telephone includes a demodulator for demodulating the RF signal and a display for displaying the demodulated video data.

11. The wireless video monitoring system of claim 10, wherein the wireless transmitting camera comprises a CCTV camera, a transmitter and a modulator for modulating the video data to the RF signal.
